(19) United States
(12) Patent Application Publication
(10) Pub. No.: US 2023/0097813 A1
(43) Pub. Date: Mar. 30, 2023

(54) Burrowing Cover Assembly

(71) Applicant: Kristen May, Santa Rosa Valley, CA (US)

(72) Inventor: Kristen May, Santa Rosa Valley, CA (US)

(21) Appl. No.: 17/487,651

(22) Filed: Sep. 28, 2021

(51) Int. Cl. A01K 1/035

(52) U.S. Cl. CPC A01K 1/0353

(57) ABSTRACT

A burrowing cover assembly includes a first belt that has a diameter sufficiently large to facilitate the first belt to be positioned around a pet bed to facilitate a pet to burrow beneath the first belt when the pet lies on the pet bed. A second belt is provided that has a diameter sufficiently large to facilitate the second belt to be positioned around the pet bed to facilitate the pet to burrow beneath the second belt when the pet lies on the pet bed. The second belt is attached to the first belt and the second belt is oriented perpendicular with the first belt. In this way the first belt and the second belt forms an X to extend around the pet bed in different directions from each other.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to burrowing device and more particularly pertains to a new burrowing device for facilitating a pet to burrow on a pet bed. The device includes a pair of belts that are attached to each other to define an X. The belts are positionable around pet bed to facilitate the pet to burrow beneath either the first or the second belt.

### (2) Description of Related Art Including Information Disclosed Under 37 CFR 1.97 and 1.98

The prior art relates to burrowing devices including a variety of pet beds that includes a blanket that is integrated into a pet bed to facilitate a pet to burrow on the pet bed. The prior art discloses a pet bed that includes a plurality of cushions oriented at an angle with each other to define a burrow for a pet.

### BRIEF SUMMARY OF THE INVENTION

An embodiment of the disclosure meets the needs presented above by generally comprising a first belt that has a diameter sufficiently large to facilitate the first belt to be positioned around a pet bed to facilitate a pet to burrow beneath the first belt when the pet lies on the pet bed. A second belt is provided that has a diameter sufficiently large to facilitate the second belt to be positioned around the pet bed to facilitate the pet to burrow beneath the second belt when the pet lies on the pet bed. The second belt is attached to the first belt and the second belt is oriented perpendicular with the first belt. In this way the first belt and the second belt forms an X to extend around the pet bed in different directions from each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a burrowing cover assembly according to an embodiment of the disclosure.

FIG. 2 is a bottom view of an embodiment of the disclosure.

FIG. 3 is a front view of an embodiment of the disclosure.

FIG. 4 is a perspective in-use view of an embodiment of the disclosure.

### DETAILED DESCRIPTION OF THE INVENTION

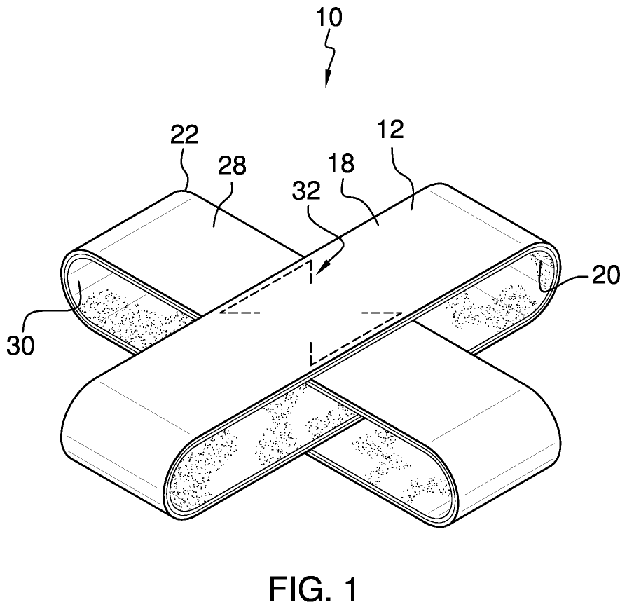

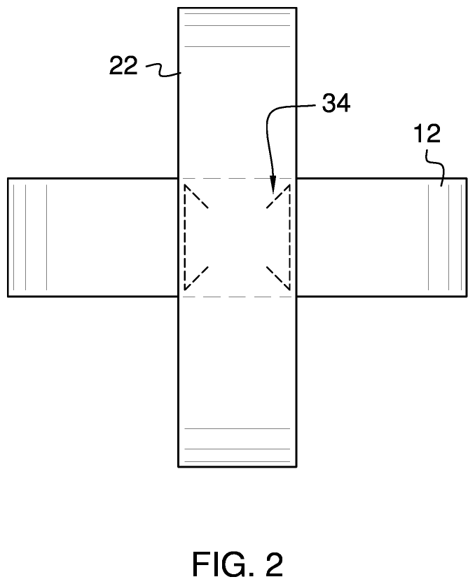

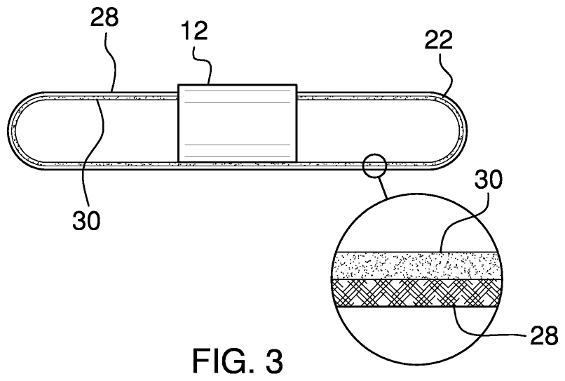

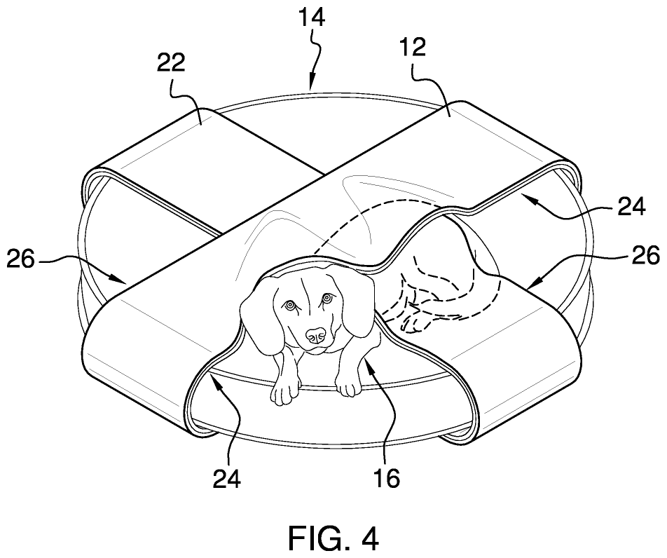

With reference now to the drawings, and in particular to FIGS. 1 through 4 thereof, a new burrowing device embodying the principles and concepts of an embodiment of the disclosure and generally designated by the reference numeral 10 will be described.

As best illustrated in FIGS. 1 through 4, the burrowing cover assembly 10 generally comprises a first belt 12 that has a diameter which is sufficiently large to facilitate the first belt 12 to be positioned around a pet bed 14. In this way the first belt 12 can facilitate a pet 16 to burrow beneath the first belt 12 when the pet 16 lies on the pet bed 14. The pet 16 may be a domesticated dog of any size or breed and the pet bed 14 may be a dog bed of any conventional design and size. Additionally, the pet bed 14 may be a rounded pet bed, a squared pet bed or any other shape of pet bed.

The first belt 12 comprises an outer layer 18 and an inner layer 20, and the outer layer 18 is exposed when the first belt 12 is positioned around the pet bed 14. Furthermore, the inner layer 20 rests against the pet bed 14 when the first belt 12 is positioned around the pet bed 14. The outer layer 18 is comprised of a resilient textile material, including but not being limited to denim or canvas, to resist being damaged by the pet 16. The inner layer 20 is comprised of a compressible textile material, including but not being limited to cotton fleece or terry cloth, to enhance comfort for the pet 16.

A second belt 22 is provided that has a diameter sufficiently large to facilitate the second belt 22 to be positioned around the pet bed 14. In this way the second belt 22 facilitates the pet 16 to burrow beneath the second belt 22 when the pet 16 lies on the pet bed 14. The second belt 22 is attached to the first belt 12 and the second belt 22 is oriented perpendicular with the first belt 12 such that the second first belt 12 and the second belt 22 forms an X. In this way each of the first belt 12 and the second belt 22 can extend around the pet bed 14 in different directions from each other. Additionally, the first belt 12 and the second belt 22 define a plurality of exits 24 and entrances 26 on the pet bed 14 for the pet 16 to burrow. Each of the first belt 12 and the second belt 22 facilitate the pet 16 to burrow when the pet 16 flips over the pet bed 14.

The second belt 22 comprises an exterior layer 28 and an interior layer 30, and the exterior layer 28 is exposed when the second belt 22 is positioned around the pet bed 14. The interior layer 30 rests against the pet bed 14 when the second belt 22 is positioned around the pet bed 14. The exterior layer 28 is comprised of a resilient textile material, including but not being limited to denim or canvas, to resist being damaged by the pet 16. The interior layer 30 is comprised of a compressible textile material, including but not being limited to cotton fleece or terry cloth, to enhance comfort for the pet 16.

The second belt 22 is attached to the first belt 12 at a first connection point 32. Additionally, the exterior layer 28 of the second belt 22 abuts the inner layer 20 of the first belt 12 at the first connection point 32. The second belt 22 is attached to the first belt 12 at a second connection point 34. The interior layer 30 of the second belt 22 abuts the outer layer 18 of the first belt 12 at the second connection point 34. The first connection point 32 and the second connection point 34 are spaced 180.0 degrees apart from each other with respect to a closed loop defined by the second belt 22. Furthermore, each of the first belt 12 and the second belt 22 may have a width ranging between approximately 18.0 inches and 24.0 inches and a length ranging between approximately 3.0 feet and 6.0 feet. Each of the first connection point 32 and the second connection point 34 may comprise stitching to attach the first belt 12 to the second belt 22.

In use, the first belt 12 and the second belt 22 are extended around the pet bed 14. In this way the pet 16 can burrow beneath either the first belt 12 or the second belt 22 when the pet 16 lies on the pet bed 14. Additionally, the first belt 12 and the second belt 22 define the plurality of exits 24 and entrances 26 for the pet 16 to employ when burrowing. The pet 16 can also continue to burrow when the pet 16 flips the pet bed 14 over. In this way the first belt 12 and the second belt 22 enhance the pet's 16 satisfaction when the pet 16 is burrowing on the pet bed 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A burrowing cover assembly being fittable around a pet cushion thereby facilitating a pet to burrow on the pet cushion, said assembly comprising:
a first belt having a diameter being sufficiently large to facilitate said first belt to be positioned around a pet bed wherein said first belt is configured to facilitate a pet to burrow beneath said first belt when the pet lies on the pet bed; and
a second belt having a diameter sufficiently large to facilitate said second belt to be positioned around the pet bed wherein said second belt is configured to facilitate the pet to burrow beneath said second belt when the pet lies on the pet bed, said second belt being attached to said first belt, said second belt being oriented perpendicular with said first belt such that said first belt and said second belt forms an X wherein each of said first belt and said second belt is configured to extend around the pet bed in different directions from each other.

2. The assembly according to claim 1, wherein:
said first belt comprises an outer layer and an inner layer, said outer layer being exposed when said first belt is positioned around the pet bed, said inner layer resting against the pet bed when said first belt is positioned around the pet bed;
said outer layer is comprised of a resilient textile material wherein said outer layer is configured to resist being damaged by the pet; and
said inner layer is comprised of a compressible textile material wherein said inner layer is configured to enhance comfort for the pet.

3. The assembly according to claim 2, wherein:
said second belt comprises an exterior layer and an interior layer, said exterior layer being exposed when said second belt is positioned around the pet bed, said interior layer resting against the pet bed when said second belt is positioned around the pet bed;
said exterior layer is comprised of a resilient textile material wherein said exterior layer is configured to resist being damaged by the pet; and
said interior layer is comprised of a compressible textile material wherein said interior layer is configured to enhance comfort for the pet.

4. The assembly according to claim 1, wherein:
said second belt is attached to said first belt at a first connection point; and
an exterior layer of said second belt abuts an inner layer of said first belt at said first connection point.

5. The assembly according to claim 4, wherein:
said second belt is attached to said first belt at a second connection point; and
an interior layer of said second belt abuts an outer layer of said first belt at said second connection point.

6. The assembly according to claim 5, wherein said first connection point and said second connection point are spaced 180.0 degrees apart from each other with respect to a closed loop defined by said second belt.

7. A burrowing cover assembly being fittable around a pet cushion thereby facilitating a pet to burrow on the pet cushion, said assembly comprising:
a first belt having a diameter being sufficiently large to facilitate said first belt to be positioned around a pet bed wherein said first belt is configured to facilitate a pet to burrow beneath said first belt when the pet lies on the pet bed, said first belt comprising an outer layer and an inner layer, said outer layer being exposed when said first belt is positioned around the pet bed, said inner layer resting against the pet bed when said first belt is positioned around the pet bed, said outer layer being comprised of a resilient textile material wherein said outer layer is configured to resist being damaged by the pet, said inner layer being comprised of a compressible textile material wherein said inner layer is configured to enhance comfort for the pet; and
a second belt having a diameter sufficiently large to facilitate said second belt to be positioned around the pet bed wherein said second belt is configured to facilitate the pet to burrow beneath said second belt when the pet lies on the pet bed, said second belt being attached to said first belt, said second belt being oriented perpendicular with said first belt such that said first belt and said second belt forms an X wherein each of said first belt and said second belt is configured to extend around the pet bed in different directions from each other, said second belt comprising an exterior layer and an interior layer, said exterior layer being exposed when said second belt is positioned around the pet bed, said interior layer resting against the pet bed when said second belt is positioned around the pet bed, said exterior layer being comprised of a resilient textile material wherein said exterior layer is configured to resist being damaged by the pet, said interior layer being comprised of a compressible textile material wherein said interior layer is configured to enhance comfort for the pet, said second belt being attached to said first belt at a first connection point, said exterior layer of said second belt abutting said inner layer of said first belt at said first connection point, said second belt being attached to said first belt at a second connection point, said interior layer of said second belt abutting said outer layer of said first belt at said second connection point, said first connection point and said second connection point being spaced 180.0 degrees apart from each other with respect to a closed loop defined by said second belt.

8. A burrowing cover system being fittable around a pet cushion thereby facilitating a pet to burrow on the pet cushion, said system comprising:
a pet bed being configured to have a pet lie on said pet bed;
a first belt having a diameter being sufficiently large to facilitate said first belt to be positioned around said pet bed wherein said first belt is configured to facilitate the pet to burrow beneath said first belt when the pet lies on said pet bed, said first belt comprising an outer layer and an inner layer, said outer layer being exposed when said first belt is positioned around said pet bed, said inner layer resting against said pet bed when said first belt is positioned around said pet bed, said outer layer being comprised of a resilient textile material wherein said outer layer is configured to resist being damaged by the pet, said inner layer being comprised of a compressible textile material wherein said inner layer is configured to enhance comfort for the pet; and
a second belt having a diameter sufficiently large to facilitate said second belt to be positioned around said pet bed wherein said second belt is configured to facilitate the pet to burrow beneath said second belt when the pet lies on said pet bed, said second belt being attached to said first belt, said second belt being oriented perpendicular with said first belt such that said second first belt and said second belt forms an X wherein each of said first belt and said second belt is configured to extend around said pet bed in different directions from each other, said second belt comprising an exterior layer and an interior layer, said exterior layer being exposed when said second belt is positioned around said pet bed, said interior layer resting against said pet bed when said second belt is positioned around said pet bed, said exterior layer being comprised of a resilient textile material wherein said exterior layer is configured to resist being damaged by the pet, said interior layer being comprised of a compressible textile material wherein said interior layer is configured to enhance comfort for the pet, said second belt being attached to said first belt at a first connection point, said exterior layer of said second belt abutting said inner layer of said first belt at said first connection point, said second belt being attached to said first belt at a second connection point, said interior layer of said second belt abutting said outer layer of said first belt at said second connection point, said first connection point and said second connection point being spaced 180.0 degrees apart from each other with respect to a closed loop defined by said second belt.
